(19) United States
(12) Patent Application Publication
(10) Pub. No.: US 2019/0213600 A1
(43) Pub. Date: Jul. 11, 2019

(54) SYSTEMS AND METHODS FOR DETERMINING COMPONENT FAILURE RATES AND IN SITU PRODUCT WARRANTY REGISTRATION

(71) Applicant: PartProtection, LLC, San Antonio, TX (US)

(72) Inventors: Tom Lee Dinwiddie, Murieta, CA (US); Christopher S. Rand, Chesterfield, VA (US); Michael T. Lucas, Del Mar, CA (US)

(21) Appl. No.: 16/243,825

(22) Filed: Jan. 9, 2019

Related U.S. Application Data
(60) Provisional application No. 62/615,315, filed on Jan. 9, 2018.

(51) Int. Cl. G06Q 30/00; G06N 3/08

(52) U.S. Cl. CPC G06Q 30/012; G06N 3/08

(57) ABSTRACT

Systems and Methods determine a failure rate or time period for anticipated failure for a component of a product or the product itself utilizing data sets comprising a product identifier, a component identifier, and a user identifier. Product warranty registration is accomplished using the product or component identifier with a warranty identifier that enables determination of in-use date of a particular product or component, which results in more accurate determinations of component failure rates and warranty periods.

### CROSS REFERENCE TO RELATED APPLICATIONS

This application and any patent resulting therefrom claim the benefit of U.S. Prov. Pat. App. No. 62/615,315 filed on Jan. 9, 2018, the entirety of which is hereby incorporated by reference.

### BACKGROUND OF THE INVENTION

Field of the invention: The present disclosure relates to systems and methods for determining first use dates of an apparatus and/or sub components of the apparatus. The present disclosure also relates to systems and methods of registering and managing warranty information for consumer products, and for providing warranty service to consumers.

It is common for an identification card or reply post card to be included in products to help register and link the product's serial number with warranty and ownership data. Increasingly manufacturers are also allowing product registrations on their websites. Such registration data includes the owners name, address, date of purchase or installation of the product, name of dealer or store, and may also include installer's name, age, income range, reason for purchase, and other demographic information.

The manufacturer desires to know this information at least in part so that they may know the date the product went into service. Given this date, they can calculate the expiration date of the warranty and avoid disputes about warranty claims on expired warranties. They can avoid having to provide warranty service after the termination of the warranty. For example, see LoVasco, et al., U.S. Pat. No. 6,208,853, of Mar. 27, 2001 which relates to an automated cell phone product warranty registration system.

Manufacturers also use this information as a source of marketing leads and demographics, including using this information to advertise to previous purchasers. However, most purchasers of such products do not complete and mail in these warranty cards or go online to register the warranty.

Manufacturers of consumer products have attempted to improve the rate at which consumers register the warranties on products for several reasons, including without limitation the desire to track the demographics of purchasers, to notify consumers of improvements or recalls, and to track the date the product was put in service or purchased in order to determine when the warranty has expired.

Methods which manufacturers have tried include contests which a consumer can enter by returning the warranty form and thereby possibly winning a prize. Another method has been to set up online registration web pages which is more convenient for some purchasers than returning a warranty card. However, in spite of expensive campaigns and other efforts of manufacturers of consumer products, some believe that less than 10% of product warranty cards are returned to the manufacturers, and only a small percentage of purchasers bother to go online to register their warranties.

Some smaller products or products that are considered consumables have not been classically subject to warranty. Even when a warranty is offered on these products an owner must first verify with the manufacturer that the product is still under warranty, then the owner must determine the service location, and then the owner must bring the product or send it to the appropriate service location. These steps are time consuming and for some owners, very difficult to accomplish. This process is also a burden on the manufacturer because the consumer will typically have to call a toll-free manufacturer number to find out the service location and whether the warranty is still in force, as well as details as to how to return the defective product for service.

The prior art lacks an efficient manner for determining and/or verifying first use dates of apparatuses, much less parts of apparatuses (such as vehicle parts).

### SUMMARY OF THE INVENTION

The current disclosure includes systems and methods for determining first use dates of an apparatus and/or sub components of the apparatus. The present disclosure also relates to systems and methods of registering and managing warranty information for consumer products, and for providing warranty service to consumers.

Systems and methods described herein may provide increased registration rates of warranties via automated, POS, consumer applications, and manual means. Registration can take place at the point of sales, or afterwards. A centralized data repository for warranty information may consolidate vendors, suppliers, and consumers into a single minable data source. Enhanced trend and pattern recognition for warranties using state of the art algorithms against the central database may be utilized. Anonymous consumer notification of warranty information and recalls is also contemplated. Using risk analysis, pre-emptive offers for warranties based upon facts may be offered to the consumer. These may be enhanced, extended, or sub set warranties.

Certain embodiments of systems and methods disclosed herein determine a failure rate or time period for anticipated failure for a component of a product or the product itself utilizing data sets comprising a product identifier, a component identifier, and a user identifier. Product warranty registration is accomplished using the product or component identifier with a warranty identifier that enables determination of in-use date of a particular product or component, which results in more accurate determinations of component failure rates and warranty periods.

It is an object of the present disclosure to provide an improved method of supporting warranties for complete products (units), consumables, and sub set warranties covering individual parts of units.

Another object of the current disclosure is to provide an improved system for tracking product owner data and facilitating return or repair of products to the owner as warranted.

A further object of the current disclosure is to provide an improved method for determining whether a warranty is in force and servicing a defective product under an in-force warranty.

An additional object of the current disclosure is to provide an improved system for providing and managing subset warranties with minimal impact on existing operational infrastructure.

Yet another object is to use information gathered by mobile devices to collect information used to determine if there is negligence on behalf of the consumer, misuse of the part and/or a likely manufacturing error.

As used herein, the term “mobile device” is a portable electronic device that includes devices such as a mobile phone, table computer, motor vehicle, aircraft, and boat.

The systems and methods disclosed herein may rely upon or operate in conjunction with one or more embodiments disclosed in U.S. patent application Ser. No. 15/792,715 entitled “ENHANCED LOCALITY COMMUNICATION SYSTEM,” filed on Oct. 24, 2017 and its related disclosures, the entireties of which are hereby incorporated by reference.

These objects are achieved by the systems and methods described herein which comprise at least in one aspect a method for obtaining warranty registration of products, facilitating warranted repair or replacement of products, and expediting warranty service on defective products comprising providing a unique identifier associated with each product; providing a pervasive warrant system comprising the steps of offering each product with warranted service pricing and a common network warranty registry inclusive of mobile device and service metrics; and offering a common service interface which is independent of location or provider.

Some embodiments of the current disclosure include a system comprising one or more processors executing programming logic, the programming logic configured to receive a plurality of data sets on a component of a product, where each data set comprises a product identifier, a component identifier, and a user identifier; derive a dynamic actuarial table utilizing data comprising the data set; and determine an anticipated period of time to failure for the component. The programming logic is configured to derive a dynamic actuarial table by correlating user attributes associated with the user identifier of the plurality of data sets. The product is a vehicle. The component is a part of a vehicle. The programming logic is further configured to receive a request for the anticipated period of time to failure for the component. The programming logic is further configured to transmit to a remote system the anticipated period of time to failure for the component. Each data set of the plurality of data sets on a component further comprises a warranty identifier.

Further, some embodiments of the current disclosure include a system comprising one or more processors executing programming logic, the programming logic configured to receive a plurality of data sets on a component of a product, where each data set comprises a product identifier, a component identifier, and a user identifier; derive a dynamic actuarial table utilizing data comprising the data set; receive a time period; and determine a likelihood of failure during the time period for the component. The programming logic is configured to derive a dynamic actuarial table by correlating user attributes associated with the user identifier of the plurality of data sets. The product is a vehicle. The component is a part of a vehicle. The programming logic is further configured to receive a request for the likelihood of failure during the time period for the component. The programming logic is further configured to transmit to a remote system the likelihood of failure during the time period for the component. Each data set of the plurality of data sets on a component further comprises a warranty identifier. The time period is a requested warranty period.

Other embodiments of the current disclosure include a method for determining a failure rate of a component of a product comprising the steps of: receiving a plurality of data sets on a component of a product, where each data set comprises a product identifier, a component identifier, and a user identifier; deriving a dynamic actuarial table utilizing data comprising the data set; receiving a time period; and determining a likelihood of failure during the time period for the component. The step of deriving a dynamic actuarial table comprises correlating user attributes associated with the user identifier of the plurality of data sets. The product is a vehicle. The component is a part of a vehicle. The method further comprises the step of receiving a request for the likelihood of failure during the time period for the component.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future. Furthermore, the use of plurals can also refer to the singular, including without limitation when a term refers to one or more of a particular item; likewise, the use of a singular term can also include the plural, unless the context dictates otherwise.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

There has thus been outlined, rather broadly, the more important features of the invention in order that the detailed description thereof may be better understood, and in order that the present contribution to the art may be better appreciated. There are additional features of the invention that will be described hereinafter and which will also form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention

FIG. 1 is a flow chart showing a method providing and managing warranty or service contracts according to selected embodiments of the current disclosure.

FIG. 2 is a flow chart showing various components and steps of a system and method according to selected embodiments of the current disclosure.

FIG. 3 is a flow chart showing prior art methods and data locations for typical product warranties.

FIG. 4 is a flow chart showing the functional components and steps of a system detailed above to enhance the warranty process according to selected embodiments of the current disclosure.

### DETAILED DESCRIPTION OF THE INVENTION

Extended Warranties are common for whole vehicles, but creating and enabling a warranty for individual parts, consumable components or repair has previously been difficult or unachievable due to the inability to connect use of the component with the specific configuration of use. A particular embodiment of the current disclosure may be initiated when a consumer purchases a component which is indexed by its standard product number with the addition of an identifying data sequence at a retailer which offers the component warranty service. The retailer offers the purchaser the component warranty service. The retailer may explain the component warranty service at that time. If the consumer accepts the component warranty service, the retailer can ascribe a warranty service indicator to a mobile accessed account associated with the Vehicle Identification Number. The ascribed warranty service indicator is associated with a unique identifier.

One of the significant aspects of this invention is the adaptive processing system which identifies eligible parts and service and their associated risk and the actuarial effect of said risk. The adaptive processing used for risk modeling fall within the Generalized Additive Family which covers Generalized Linear Models, Generalized Additive Models, Neural Network and Boosting. In certain embodiments, a complete procedure will include one or more high dimensional predictive filters as appropriate for the nature of the part itself.

The processing of risk is based on parameters which may include description of the part, make, model, year, position, location, history and mileage. The algorithm is always evolving to become more accurate in the determination of risk.

The system allows for optimization of subcomponent service contracts for additional years beyond the manufacture warranty, as well as warranties beyond the manufacture warranty, and limited lifetime warranties for consumables such batteries, brakes, tires, and wiper blades.

In addition to determining eligibility and risk factors, the system disclosed herein may integrate with various dealer management systems (DMS) such as CDK, Reynolds and Reynolds, dealer track, and PBS to facilitate the sale. Exemplary processes are discussed in further detail below.

In an exemplary embodiment, a customer brings their car into the dealership for a repair. The repair order is entered into the DMS system. The DMS number is entered into the part protection system and the repair order information is imported into the system and checked for eligible parts and priced for the dealership. More specifically, the system receives a request for warranty data, where the request includes a part number. The system then provides a response that includes the warranty data, where the warranty data includes a price for the associated warranty or service contract. If the customer accepts the dealership may simply click a single button to print out the paperwork and add the warranty or service contract in formation back to the DMS.

In another exemplary embodiment, a customer, independent repair facility or collision center requests to purchase a part from the dealership. Again an invoice is created in the DMS and the DMS number is used to search and bring the information into the part protection system. The part is checked for eligibility and a warranty or service contract is priced, with the appropriate warranty data returned to the DMS. If the customer purchases the part the appropriate paperwork is created for the customer or repair facilities customer.

The above exemplary integrations may require dealerships to pre-configure their DMS with SKU's for the warranty and in many cases to have additional features added to their DMS to allow for direct and seamless integration with the part protection system disclosed herein.

Because the system may support such a broad range of vehicle parts and labor, alternative embodiments may provide for simplified interactions between the system and the DMS.

For example, existing SKU and price tapes that are loaded into the DMS system by the DMS providers may be obtained and utilized by the system. The system may process each of these lists through an algorithm to determine eligibility. When a SKU is eligible, the system may generate an additional part number with, for example, a prefix or suffix. In one such embodiment, if the original part is A1234 for an alternator, the additional part maybe LPP-A1234. With each newly generated part number, associated warranty data, including potential service contract data, is assembled. These augmented parts lists are then sent, transmitted, or otherwise provided to the DMS providers to load directly into their system. A Dealership is then able to sell the warranty or service contracts for parts directly from the DMS system without searching or otherwise making individual network requests to the system for each part requested or purchased.

Continuing with the example above, a customer brings her car into the dealership for a repair. The repair order is entered into the DMS system and the DMS system shows the normal manufactured SKU and price as well as the warrantied SKU and price. The customer accepts the repair as normal, without the warranty. There is no interaction with the system during the customer transaction.

In another continuation of the example above, a customer brings her car into the dealership for a repair. The repair order is entered into the DMS system and the DMS system shows the normal manufactured SKU and price as well as the warrantied SKU and price. The customer accepts the repair with the warranty. There is no interaction with the system during the customer transaction. However, the DMS paperwork produced during the transaction may include instructions for how the customer may lookup their warranty terms and paperwork through an Internet website using the standard part comment and description fields. Nightly, or upon some other set schedule, the system herein may communicate with the local DMS system and search for all warrantied SKU's and download repair order, or part order information. This information may be sent to the appropriate underwriter. Using the downloaded information from the DMS, the customer will get a follow-up email, text message, or other form of communication with their warranty information.

Several aspects of the current disclosure may provide unique and distinct advantages over the prior art. Use of an adaptive filter system to overlay relative risk parameters on a mobile e user basis to identify eligible parts and labor for a repair based upon vehicle and customer attributes enables the efficient provision of warranty services without unreasonable risk. Use of product identifiers and tracking, such as by using the systems and methodologies in U.S. patent application Ser. No. 15/792,715 to determine and track risk among parts and labor based upon vehicle and customer attributes for underwriting purposes enables an efficient mechanism for tracking and verifying critical data. The ability to identify and port through mobile devices, warranties to the appropriate underwriter based upon the terms, for example, service contracts, warranty, length of coverage, ownership, and transferability has distinct advantages over the prior art. This new system, which operates between the dealer management systems and the OEM manufacturers, seamlessly works for all parts going forward without special integration or separate software at the point of sale.

A system according to selected embodiments of the current disclosure may mitigate rapid claim rise for particular part numbers by presenting information indicative of a known recall, warranty compliance and eligibility or lack of compliance. Information from at least one mobile device is used in this determination as well as parameters associated with the part.

A particular embodiment of the current disclosure includes a system comprising one or more processors executing programming logic, the programming logic configured to receive plurality of data sets on a sub-component of a product, where each data set comprises a product identifier, a sub-component identifier, and a user identifier; derive a dynamic actuarial table utilizing the data set and correlated to user attributes associated with the user identifiers of the data sets. The product may be a vehicle and the sub-components maybe parts of the vehicle. The system may be further configured to receive a request for warranty data, where the request for warranty data comprises a user identifier; transmit warranty data in response to the request for warranty data, where the warranty data is generated utilizing the dynamic actuarial table and user attributes associated with the user identifier of the request for warranty data.

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

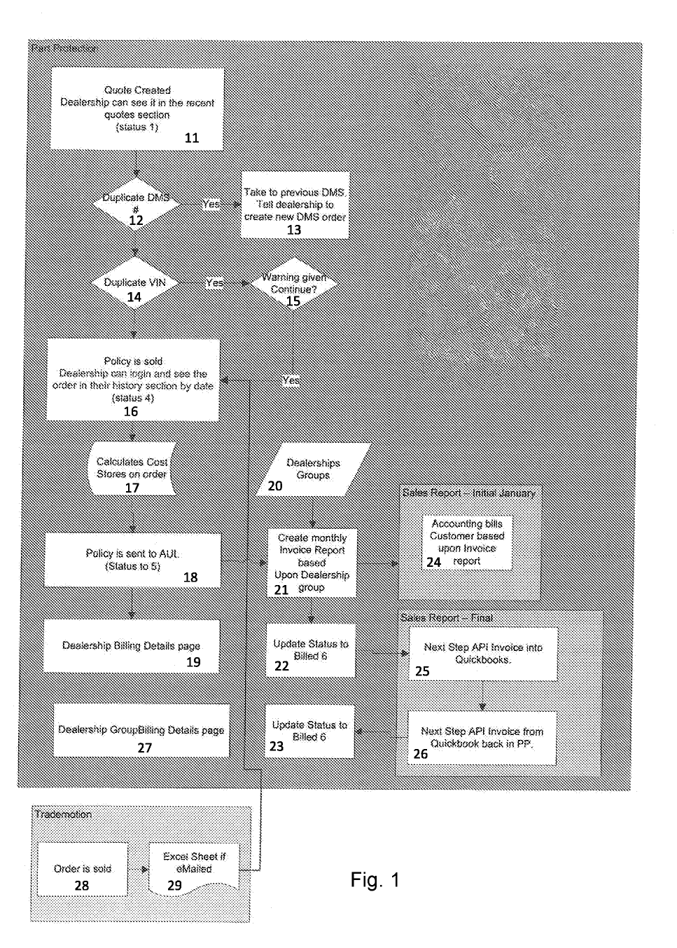

FIG. 1 is a flow chart showing a system and method providing and managing warranty or service contracts (policies) according to selected embodiments of the current disclosure. The method includes the steps of not only quoted, creating, and selling the policy, but also providing relevant sales reports and invoicing associated with the policy. A quote is created 11, and the system is checked for a duplicate DMS records 12 and duplicate VIN records 14. If a duplicate DMS record 12 is encountered, the system reverts to the previous DMS record or sends an instruction to create a new DMS order. If a duplicate VIN number is encountered 14, the system provides a warning 15. If the warning is ignored, the method continues onto selling the policy 16; otherwise the method may be terminated or revert back to creating a quote 11. A cost is calculated 17, and then the policy is sent to a service contract administrator 18. A dealership billing details page may also be provided 19, along with a dealership group billing details page, which will show billing details for a group of dealerships. Dealership groups 20 create monthly invoice reports based upon policies sold 21, which in turn lead to an updated billing status 22 and provisions to generate an invoice 25, such as through Quickbooks® accounting software. The invoice can then be sent back to the system 26, with an updated billing status 23. Sales reports bill the customers based upon invoice reports 24. Orders may be sold separately 28, and entered into a computer readable format 29, for example, an Excel® or comma separated value format, and then emailed or otherwise entered into the system as a sold policy 16.

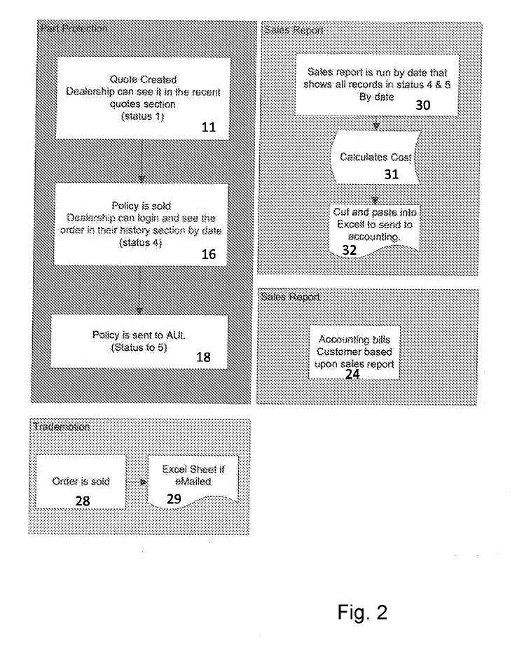

FIG. 2 is a flow chart showing components and steps of a system and method according to selected embodiments of the current disclosure. Dealerships or other service providers interact with the system to manage warranty and service contracts and view relevant reports, such as sales reports, even though each subsystem may not communicate all details to the other subsystems. For example, the system may not record when a particular policy is billed or paid, but rather just when it is sold. A quote for a warranty contract/policy is created 11, and is subsequently sold 16, and sent to the service contracts administrator 18. Separately, a sales report is generated by date 30, costs are calculated 31, and manually sent to accounting 32. A customer bill is generated based upon sales reports 24. As with FIG. 1, a separate order is sold 28 and transmitted via a computer readable format 29.

An Application Program Interface (API) provides a method for vendors and suppliers to register warranty information at the point of sale or afterward. The API can be used to supply customer information, household information, product information, warranty terms, and purchase information.

Many point of sales (POS) systems now offer an email receipt option. Using existing mail server technology, the receipts sent via email can be cc'd to the central registration system. SKU and product descriptions are used to register the products under the customers email and information.

Corporate feeds can be used on a scheduled basis, usually nightly or weekly to send registration information to the central register system. The information would include products, customer, warranty terms, and purchase information.

Using the consumer application, a person may register any purchases manually by entering purchase information and product information.

With permission to access credit card purchases granted by the consumer through the consumer application, the central warranty registration system will pull purchase information to automatically register warranties. Some credit cards already allow extended warranties, the information gained through this method can provide service dates, as well as perhaps extend an already extended warranty.

One of the significant aspects of current disclosure is the adaptive processing system which identifies eligible parts and service and their associated risk and the actuarial effect of said risk. The adaptive processing used for risk modeling fall within the Generalized Additive Family which covers Generalized Linear Models, Generalized Additive Models, Neural Network and Boosting. Such adaptive processing is enabled at least in part by the accurate determination of first in use dates of a particular part or component.

The complete procedure will include one or more high dimensional predictive filters as appropriate for the nature of individual parts itself as well as advanced artificial intelligence algorithms to identify patterns in various demographics including consumer information, household information, location of part or end unit, supplier, vendor, and manufacturer information. Failure rates or risk assessment on these are any additional filters can be used to underwrite, notify, and protect the consumer.

The process starts with assigning baseline categories to parts using keyword recognition. Parts lists can come from a variety sources, such as auto manufacturers, third party lists, ACES standard, and DMS. Keywords may be recognized as a complete string or within a larger string depending on need. A stock keeping unit (SKU) may be categorized into multiple categories. Based upon these categories the SKU is assigned an initial eligibility determination and baseline risk which is used for pricing and reserves. An example would be differentiating between the descriptions of oil change, oil filter, and oil filter pump.

From there the system adapts (learns) based upon various inputs. Each time a repair order is searched from a DMS the system now understands the parts being repaired and replaced. Using this information the system can alter various weights based upon vehicle type, year, make, model, customer demographics, even dealership location. This information is used to develop various risk models. The models use standard smoothing techniques (linear) to remove outlying entries and limit moving the weight too quickly. Ultimately these actuarial models are used then used to modify the eligibility, pricing, and initial categorization filters.

In addition to the standard pattern recognition queries above that recognize know patterns such category, vehicle, owners etc. The learning algorithm also uses a neural network to recognize unintended patterns. Neural networks become more accurate with increased training therefore as the use of the system increases the results will increase as well.

Identifying sub warranty (part) is one of the systems major outcomes. Many systems do not need a full warranty that may be expensive, when a warranty on one or more parts may be more cost effective and beneficial for the consumer. This can be applied to many end user products. For instance, in the automotive field extended warranties on the vehicle are common, but perhaps getting protection for a water pump that is getting close to failure may be a better value for the consumer.

Identifying sub-warranty (part) is one of the systems significant advantages. Many systems do not need a full warranty that maybe expensive, when a warranty on one or more parts maybe more cost effective and beneficial for the consumer.

Additionally, identifying when a product changes locations, households or owners may benefit consumers, manufacturers, or both.

The consumer application can be used to register purchases and warranties. Purchase enhanced, or extended warranties. Additionally, it can used to receive consumer information, recalls, and additional product information.

The consumer application interfaces with the central warranty database, but is not limited to such an interface. It also interfaces with various consumer sources for notices, recalls, and warnings. Using geolocation features of the cell phone it can help identify information that maybe of relevance to the consumer.

The consumer application and all information is also accessible via a website.

Another important aspect of the consumer application is the ability to keep the consumers identity anonymous. Many applications, search engines, etc. sell consumers' information to the highest bidder. Advertisements and marketing programs continue to follow the consumer after the initial contact. The consumer application in this case acts as a buffer allowing a consumer to register products without providing their identify. Manufacturers and companies wishing to reach a consumer need to contact them through the application.

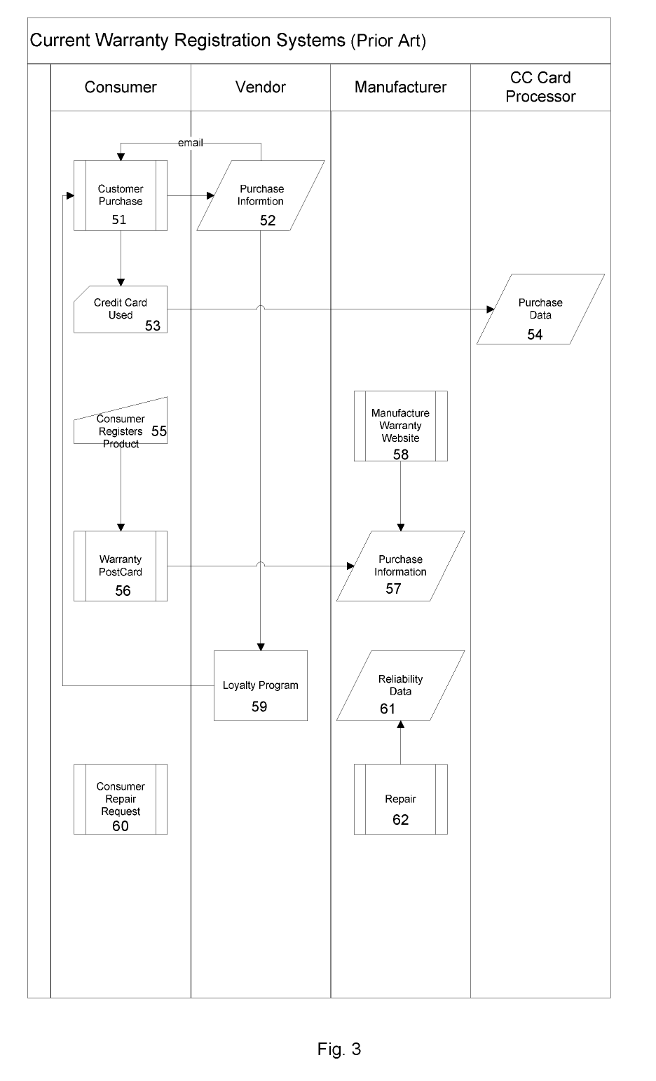

FIG. 3 is a flow chart showing prior art methods and data locations for typical product warranties. A customer purchases a policy 51 using a financial instrument 53 such a credit card, and the purchase data 54 is transmitted to the appropriate financial institution for processing. Purchase information 52 is also provided to the vendor, which may be used to populate and/or update a loyalty program 59. Separately from the purchase of the warranty policy, the consumer registered the product 55 using a warranty postcard 56, which is sent to the manufacturer with purchase information 57. Alternatively, the user may enter such product information through the manufacturer's website 58. A consumer, once again separately from the other transactions, can request a repair 60, which repair 62 is performed by the manufacturer, which may generate reliability data 61. However, as can be seen, this segregated data and systems limits the ability to determine in use dates as well as generate dynamic actuarial tables to accurately determine failure rates of individual components (also referred to as sub-components) of a product.

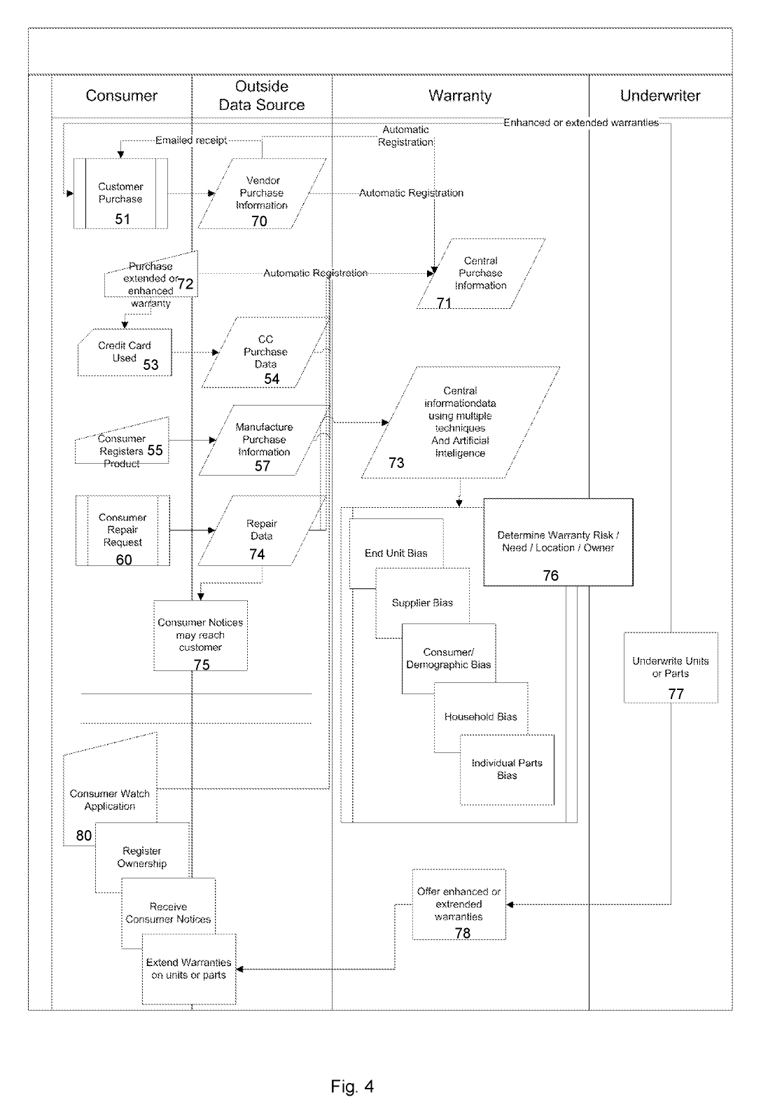

FIG. 4 is a flow chart showing the functional components and steps of a system detailed above to enhance the warranty process according to selected embodiments of the current disclosure. A customer purchases a product or sub component of the product 51, and the vendor receives purchase information 70. Basic warranties may be included, which are provided to a central purchase information system 71. The consumer may purchase an extended or enhanced warranty for the product or subcomponent 72, and uses a financial instrument 53 to purchase, where the purchase data 54 is sent to a financial institute for processing. This information is also used to automatically register the product or component as in use. However, even if a warranty is not purchased, the product and purchase information is nonetheless recorded such that more accurate dynamic actuarial tables may be generated. A central information system 73 stores and processes the data, including repair data 74, to derive dynamic actuarial tables which can be used to determine an anticipated period of time to failure or likelihood of failure during a time period. This data is then used to create a warranty risk 76 and thus resulting costs of providing such a warranty. Because of the automatic product registration, consumers may be notified 75 of important information such as recalls, or servicing requirements to maintain their warranty. Such a system may also integrate with a consumer watch application 80 to provide said notices to consumers. Furthermore, the registration data combined with the dynamic actuarial data can allow underwriting of products or parts 77 separate from the initial point of sale to offer enhanced or extended warranties 78 separate from the original sales transaction.

The derivation of the dynamic actuarial table can be accomplished by analyzing first use dates, failure dates, component identifications, product identifications, and user identifications. For example, certain components of a product may have a higher failure rate in a given time period as compared to the same components of a different product. Likewise, the user data may indicate a higher or lower failure rates. Accordingly, more accurate failure rates may be determined not only for the product itself, but also in light of the environmental factors surrounding that component.

While various embodiments of the present invention have been described above, it should be understood that they have been presented by way of example only, and not of limitation. Likewise, the various diagrams may depict an example architectural or other configuration for the invention, which is provided to aid in understanding the features and functionality that can be included in the invention. The invention is not restricted to the illustrated example architectures or configurations, but the desired features can be implemented using a variety of alternative architectures and configurations.

Indeed, it will be apparent to one of skill in the art how alternative functional configurations can be implemented to implement the desired features of the present invention. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

That which is claimed:

1. A system comprising one or more processors executing programming logic, the programming logic configured to receive a plurality of data sets on a component of a product, where each data set comprises a product identifier, a component identifier, and a user identifier; derive a dynamic actuarial table utilizing data comprising the data set; and determine an anticipated period of time to failure for the component.

2. The system of claim 1, wherein the programming logic configured to derive a dynamic actuarial table comprises correlating user attributes associated with the user identifier of the plurality of data sets.

3. The system of claim 1, wherein the product is a vehicle.

4. The system of claim 1, wherein the component is a part of a vehicle.

5. The system of claim 1, wherein the programming logic is further configured to receive a request for the anticipated period of time to failure for the component.

6. The system of claim 1, wherein the programming logic is further configured to transmit to a remote system the anticipated period of time to failure for the component.

7. The system of claim 1, wherein each data set of the plurality of data sets on a component further comprises a warranty identifier.

8. A system comprising one or more processors executing programming logic, the programming logic configured to receive a plurality of data sets on a component of a product, where each data set comprises a product identifier, a component identifier, and a user identifier; derive a dynamic actuarial table utilizing data comprising the data set; receive a time period; and determine a likelihood of failure during the time period for the component.

9. The system of claim 8, wherein the programming logic configured to derive a dynamic actuarial table comprises correlating user attributes associated with the user identifier of the plurality of data sets.

10. The system of claim 8, wherein the product is a vehicle.

11. The system of claim 8, wherein the component is a part of a vehicle.

12. The system of claim 8, wherein the programming logic is further configured to receive a request for the likelihood of failure during the time period for the component.

13. The system of claim 8, wherein the programming logic is further configured to transmit to a remote system the likelihood of failure during the time period for the component.

14. The system of claim 8, wherein each data set of the plurality of data sets on a component further comprises a warranty identifier.

15. The system of claim 8, wherein the time period is a requested warranty period.

16. A method for determining a failure rate of a component of a product comprising the steps of:
receiving a plurality of data sets on a component of a product, where each data set comprises a product identifier, a component identifier, and a user identifier;
deriving a dynamic actuarial table utilizing data comprising the data set;
receiving a time period; and
determining a likelihood of failure during the time period for the component.

17. The method of claim 16, wherein the step of deriving a dynamic actuarial table comprises correlating user attributes associated with the user identifier of the plurality of data sets.

18. The method of claim 16, wherein the product is a vehicle.

19. The method of claim 16, wherein the component is a part of a vehicle.

20. The method of claim 16, wherein the method further comprises the step of receiving a request for the likelihood of failure during the time period for the component.
